(19) United States
(12) Patent Application Publication
(10) Pub. No.: US 2002/0087333 A1
(43) Pub. Date: Jul. 4, 2002

(54) Portable presentation device

(76) Inventor: Reng-Sho Chen, Taipei (TW)

Correspondence Address: BIRCH STEWART KOLASCH & BIRCH, PO BOX 747, FALLS CHURCH, VA, 22040-0747, US

(21) Appl. No.: 09/750,156

(22) Filed: Dec. 29, 2000

(51) Int. Cl. G05B 15/00; G06F 17/60

(52) U.S. Cl. 705/1; 700/83

(57) ABSTRACT

A portable presentation device includes a main processor and a detachable remote control device. The main processor includes a built-in processor and a plurality of video and audio and I/O ports whereby to download presentation contents from a general computer. The device uses a preloaded driver program to transmit the presentation pictures to a LED screen, or a connected external screen or projector. The detachable remote control device may be used to emit remote control signal for switching or changing the presentation pictures.

### FIELD OF THE INVENTION

This invention relates to a small size and easy to carry presentation device and particularly a portable device that is capable of downloading presentation files and pictures from a general computer.

### BACKGROUND OF THE INVENTION

Nowadays most business people who have meetings away from the office usually take their notebook computer with them. The presentation materials and files needed for the day are stored in advance in the notebook computer. At the presentation site, they would connect the notebook computer to a projector to make presentation or business promotion.

Notebook computer is still quite expensive at present. And it is a relatively big and heavy case no matter years of efforts by producers trying to make them slim and light. It is a highly delicate equipment that needs extreme care to handle and use. An incidental dropping of the computer could cause serious damage or destroying information files. Furthermore, the information files could be very much valuable and highly sensitive and have great confidentiality nature. In case of the notebook computer gets lost or stolen during travel, it could result in serious damage or consequence to the organization. Therefore it is not commendable to carry notebook computer for every presentation outside the office.

It would be far more advisable to have a simpler and compact device than notebook computer that can download in advance the presentation materials from general computers. Then the presenter needs only to carry a small set of device to the presentation site. It would be more convenient and safer, and without the risk of losing business confidential information.

### SUMMARY OF THE INVENTION

In view of aforesaid requirements, it is therefore an object of this invention to provide a portable presentation device that is capable of downloading therein ready presentation files from general computers for field trip use. The device has a main processor display screen for previewing, or connecting to an external display device for broadcasting the presentation materials.

The portable presentation device according to this invention includes an assembly constituted a main processor and a remote control device. The main processor includes a presentation processor and a plurality of input and output ports for video, audio and memory for downloading presentation materials already completed and stored in the general computers. There is a preloaded driver program for transmitting the presentation materials to a LED screen or an external screen or a projector. The processor also may accept touch commands from the LED screen or instruction signals from the detachable remote control device for changing presentation files and pictures during presentation under a remote control operation mode.

In order to facilitate user carrying, the main processor and remote control device are engaged by means of a latch means or other equivalent means desired. When operating with an external screen or projector and with the main processor and remote control device separated, the remote control device may be used to emit remote control signal for controlling the main processor operation.

### BRIEF DESCRIPTION OF THE DRAWINGS

The invention, as well as its many advantages, may be further understood by the following detailed description and drawings, in which:

FIG. 1 is a top view of this invention.

FIG. 2 is a perspective view of this invention, with the main processor and remote control device separated.

FIG. 3 is a perspective view of a remote control device of this invention.

### DESCRIPTION OF THE PREFERRED EMBODIMENT

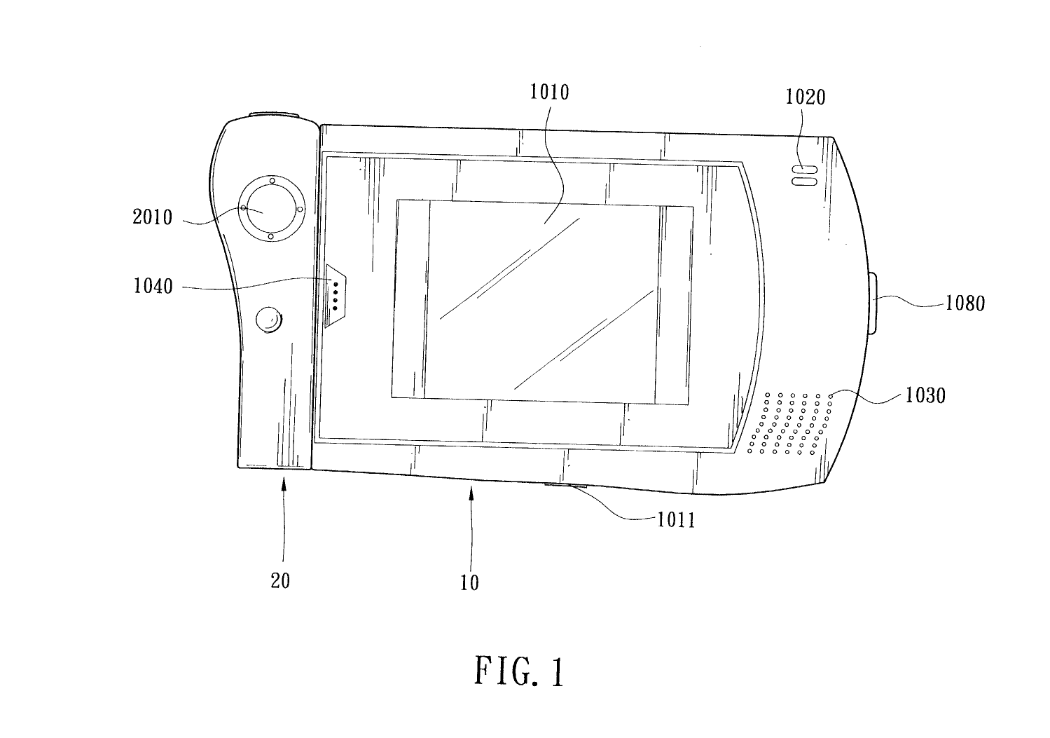

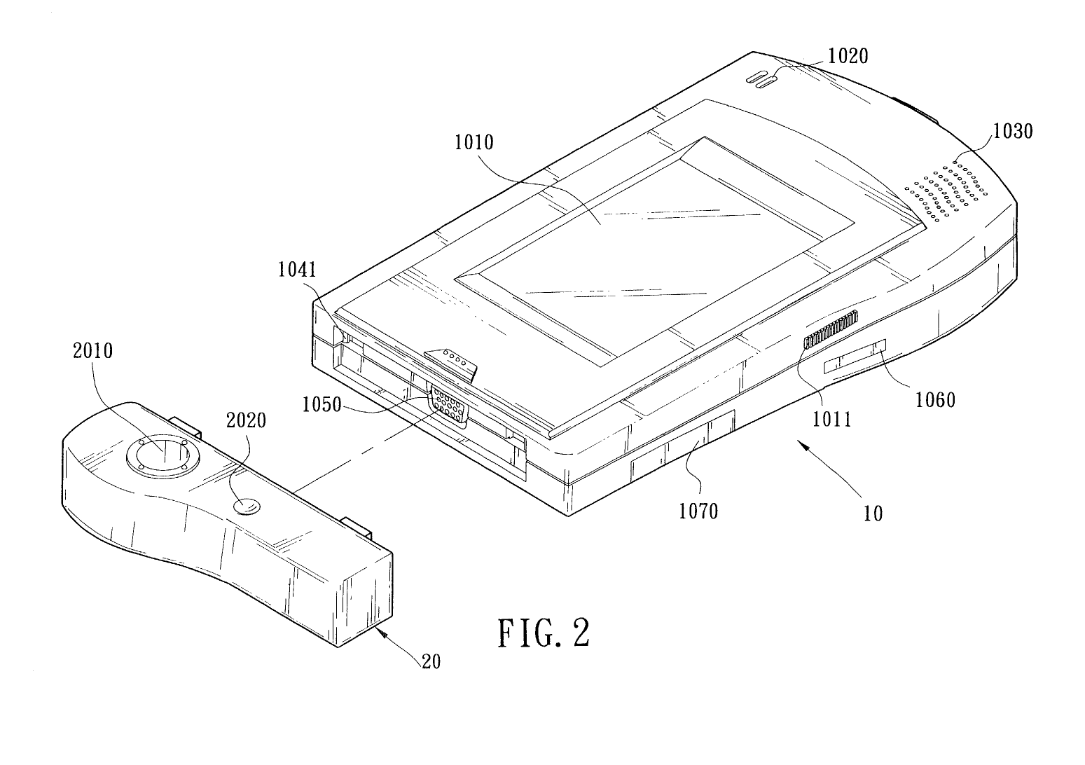

Referring to FIGS. 1 and 2, the portable presentation device according to this invention includes at least a main processor 10 coupled with a remote control device 20. The main processor 10 has a built-in processor and driver program, and links to a plurality of input and output ports for video, audio and memory, and is engageable with the remote control device 20 through a release button 1040 and a pair of latch lugs 1041 located in the main processor 10, and a pair of latch grooves 2030 actuated by a control knob 2010.

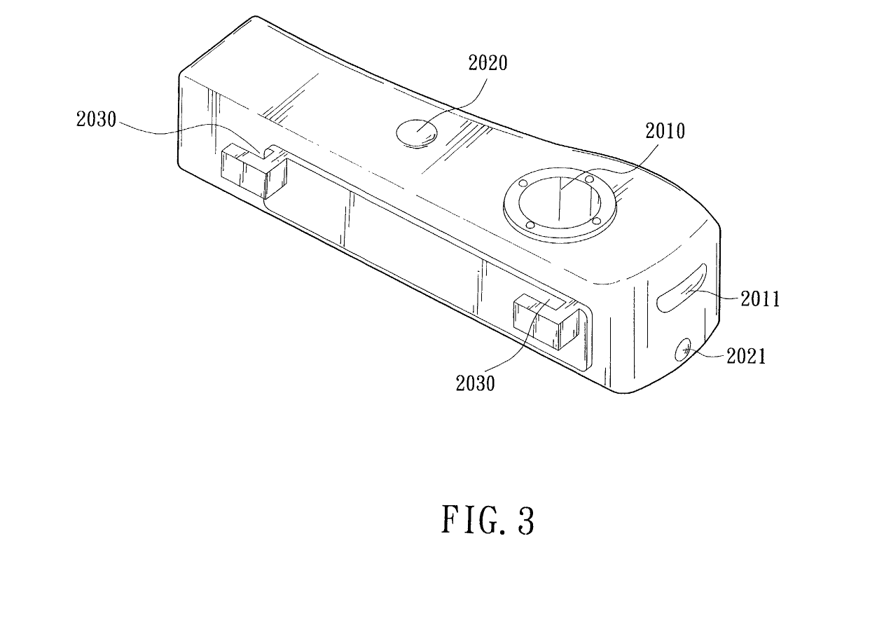

Referring to FIG. 3, the remote control device 20 has a pair of protrusive hooks to form a pair of latch groove 2030 for engaging with the latch lugs 1041 controlled by release button 1040.

When there is a need to detach the main processor 10 from the remote control device 20, press the release 1040 to move the latch lugs 1041 from the latch grooves 2030, the remote control device 20 may be separated from the main processor 10.

The engaging means set forth above is but one of common ways for fastening two articles known in the art. There are many other means available for fastening two articles, such as means using magnetic attraction force, means by hook and loop and the like. The embodiment of engaging the main processor 10 and remote control device 20 depicted above serves only as an example and should not be deemed as limitation of this invention.

Referring to FIG. 2, the casing of the main processor 10 further has a Liquid Crystal Display (LCD) screen 1010, an adjusting key 1011 for controlling bright and dark contrast of the screen, a microphone 1020, a speaker 1030, an external display connection port 1050, a flash memory card socket 1060, an I/O port protection cover (in which may include USB port, VGA port, earphone port, DC power input port and/or CF card slot), and an infrared signal window 1080 and the like. All of features set forth above are connecting with the main processor.

The LCD screen 1010 may have touch control function. The touch control generated signals are processed by the processor and programs resided in the main processor 10 whereby to select presentation files for broadcasting or switch presentation contents during presentation.

When in use, use the flash memory card socket 1060 to connect a flash memory card which is preloaded with presentation contents from the computer, and use the main processor built-in driver program to output the presentation file contents to the LCD screen 1010 for preview. Audio message of the contents may be input through the microphone 1020 and output through the speaker 1030.

When there is a need for connecting an external display for presentation, it may be done through the external display connection port 1050 or USB port or VGA port to connect an external display device (such as projector, large screen TV or the like). The presentation contents may be transmitted to the external display device for broadcasting by program.

Referring to FIG. 3, the remote control device 20 includes battery and control circuit (not shown in the figure), and a controlled knob 2010, a laser pointer button 2020, an infrared signal window 2011 and a laser pointer 2021. All these features are connecting with the control circuit. When in use, use the control knob 2010 to generate control signals which are transmitted to the infrared signal window 1080 of the main processor 10 through the infrared signal window 2011. The processor and program resided in the main processor 10 then process the requests contained in the control signals to switch the presentation files and contents. The remote control device 20 may also use the laser button 2020 to control the laser pointer 2021 to emit a laser point whereby to replace the additional laser pointer (such as pen-like laser pointer) used in general presentation occasions.

In summary, this invention enables business people and salespersons to make presentation at customers sites without carrying notebook computers, thus may minimize the exposures and risks of losing company confidential information not related to the presentation. Employing this invention, only presentation related materials and information will be carried out. It is more compact size and light weight, more convenient and safer.

It may thus be seen that the objects of the present invention set forth herein, as well as those made apparent from the foregoing description, are efficiently attained. While the preferred embodiment of the invention has been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A portable presentation device constituted a main processor and a remote control device, the main processor including a processor and driver program for processing presentation files, comprising:
a flash memory card socket for plugging a flash memory card which contains the presentation files; and
an external display connection port for the program stored in the main processor to convert the presentation files to video and audio signals and transmit to an externally connected display device for displaying.

2. The portable presentation device of claim 1, wherein the external display connection port is a VGA port.

3. The portable presentation device of claim 1, wherein the external display connection port is an USB port.

4. A portable presentation device constituted a main processor and a remote control device, the main processor including a processor and driver program for processing presentation files, comprising:
a flash memory card socket for plugging a flash memory card which contains the presentation files;
an external display connection port for the program stored in the main processor to convert the presentation files to video signals for transmitting to an externally connected display device for displaying;
a display screen for displaying the video signals when the main processor converting the presentation files to video signals ; and
a speaker for broadcasting the audio signals when the main processor converting the presentation files to audio signals.

5. The portable presentation device of claim 4, wherein the display screen is a LCD screen.

6. The portable presentation device of claim 4, wherein the display screen is a touch control screen for selecting or switching presentation contents.

7. The portable presentation device of claim 4, wherein the main processor further has a screen bright and dark contrast adjusting key for adjusting brightness and darkness and contrast value of the screen.

8. The portable presentation device of claim 4, wherein the external display connection port is a VGA port.

9. The portable presentation device of claim 4, wherein the external display connection port is an USB port.

10. The portable presentation device of claim 1, wherein the remote control device is powered by battery and has a control knob and an infrared signal window for transmitting control signals.

11. The portable presentation device of claim 10, wherein the main processor further has an infrared signal window for receiving the control signals from the remote control device to select or switch presentation contents.

12. The portable presentation device of claim 1, wherein the remote control device is powered by battery and has a laser pointer knob and a laser pointer, the laser pointer knob controlling the operation of the laser pointer.
